(19) United States
(12) Patent Application Publication
(10) Pub. No.: US 2005/0044215 A1
(43) Pub. Date: Feb. 24, 2005

(54) System for automatic import, analysis, and reporting of network configuration and status information

(76) Inventors: Alain J. Cohen, Washington, DC (US); Robert Mollitor, Rockville, MD (US); Vicki A. Tardif, Sudbury, MA (US); Vivek Narayanan, Cary, NC (US); Pradeep Singh, Arlington, VA (US)

Correspondence Address: ROBERT M. MCDERMOTT, ESQ., 1824 FEDERAL FARM ROAD, MONTROSS, VA, 22520, US

(21) Appl. No.: 10/912,704

(22) Filed: Aug. 5, 2004

Related U.S. Application Data
(60) Provisional application No. 60/497,093, filed on Aug. 22, 2003.

(51) Int. Cl. G06F 15/173

(52) U.S. Cl. 709/224

(57) ABSTRACT

An automation engine is configured to automatically run network data collection, analysis, and reporting tools. Each tool is designed or modified to enable the parameters required for operating the tool to be read from a settings file. The automation engine is configured to provide the appropriate settings file to each tool to perform a given set of tasks. Tasks can be performed on-demand, on predefined schedules, or upon detection of a triggering event.

This application claims the benefit of U.S. Provisional Patent Application No. 60/497,093, filed Aug. 22, 2003.

### BACKGROUND AND SUMMARY OF THE INVENTION

This invention relates to the field of networks and network analysis, and in particular to a system that facilitates automated network data collection, analysis, and reporting of network configuration and status information.

The management of a communications network is a complex and time-consuming task, particularly as the size and capabilities of such networks continues to grow. Changes to the configuration of a network, or changes in traffic patterns across the network, often cause problems that are difficult to anticipate or diagnose. Often, such problems remain latent until their compound effect cause network disruptions or other anomalous behavior.

Analysis and diagnostic tools are available to facilitate the identification and correction of network problems before they cause major disruptions, but often the cost and overhead associated with routinely collecting the data and performing the analysis outweigh the perceived benefits, particularly while the network appears to be operating efficiently. However, without ongoing data collection and analysis, the isolation of the cause(s) of a network disruption, when the disruption occurs, can be very time consuming, and the subsequent diagnoses may often introduce further network disruptions.

An objective of this invention is to provide an automated network analysis system that requires little or no human interaction. A further objective of this invention is to provide an automated reporting system for alerting network managers of changes to the network configuration and/or performance. A further objective of this invention is to provide a network analysis and reporting system that is easy to configure and run on a regular basis.

These objectives, and others, are achieved by providing an automation engine that is configured to automatically run network data collection, analysis, and reporting tools. Each tool is designed or modified to enable the parameters required for operating the tool to be read from a settings file. The automation engine is configured to provide the appropriate settings file to each tool to perform a given set of tasks. Tasks can be performed on-demand, on predefined schedules, or upon detection of a triggering event, such as a notification that a device configuration has changed, as reported by many vendor-supplied component management systems.

### BRIEF DESCRIPTION OF THE DRAWINGS

The invention is explained in further detail, and by way of example, with reference to the accompanying drawings wherein:

FIG. 1 illustrates an example automated network collection, analysis, and reporting system in accordance with this invention.

FIG. 2 illustrates an example control of an application/tool by an automation engine in accordance with this invention.

FIG. 3 illustrates an example method of creating settings data for configuring an application/tool in accordance with this invention.

Throughout the drawings, the same reference numerals indicate similar or corresponding features or functions. The drawings are included for illustrative purposes and are not intended to limit the scope of the invention.

### DETAILED DESCRIPTION OF THE INVENTION

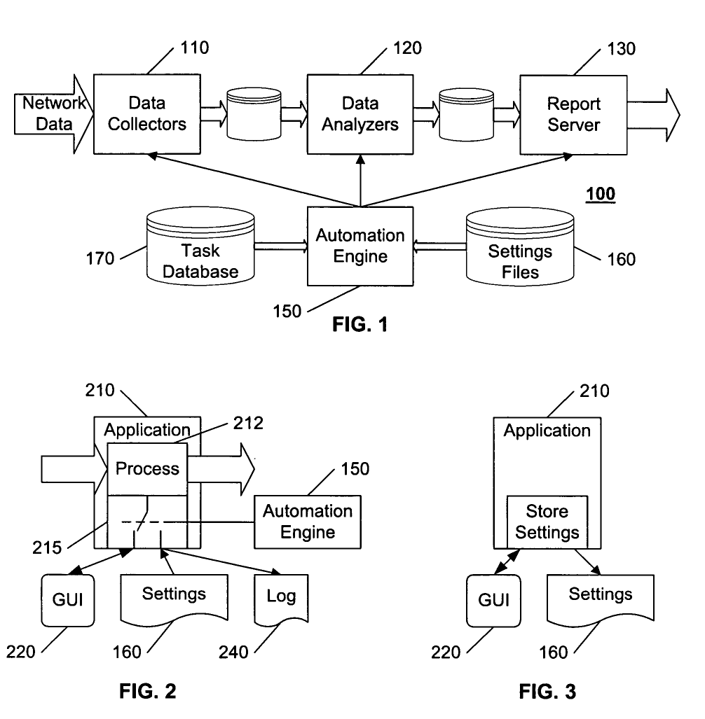

FIG. 1 illustrates an example network monitoring system 100 in accordance with this invention. The monitoring system 100 includes data collectors 110, data analyzers 120, a report server 130, and an automation engine 150.

The data collectors 110 include applications, or tools, that facilitate the collection of data related to the configuration and operation of the network. Included in this collection, for example, is a tool that collects network configuration data and creates a model of the network. The VNE (Virtual Network Environment) Server product from OPNET Technologies, Inc., Bethesda, Md., for example, provides an on-line integrated view of a network. The VNE Server collects network data from a variety of sources and merges the information to create a unified network representation that can subsequently be used for network planning, engineering, and operations. Sources of network data include, for example, routers and switches from Cisco Systems, Nortel, and others, as well as a variety of network “discovery” tools and protocols that facilitate the creation of complete topology views.

The data collectors 110 also include applications that facilitate the collection of performance data from the network. Conventional routers and switches, for example, typically include performance monitoring capabilities that can be queried from remote management systems, such as the aforementioned VNE Server.

The data analyzers 120 include applications that provide, for example: flow analysis, failure analysis, security analysis, network differences, network validation, and other analysis and/or diagnostic tools.

A network differences application, for example, compares the aforementioned network configuration data provided by the data collectors 110 at different times to identify any changes that have occurred. In accordance with this invention, the automation engine 150 is configured to allow a user to create a “task” that includes the collection of data by the data collectors 110 that determine the current network configuration, followed by the invocation of a network difference application 120 that compares the current network configuration with a prior network configuration. Also in accordance with this information, any differences that are determined may be reported to an appropriate party, via the report server 130. The report server 130 can be configured, for example, to report all changes, or to report select changes, or to report any change that is coincident with another effect reported by another analyzer 120, and so on.

In a preferred embodiment of this invention, a network differences application includes a process that determines whether the current network configuration conforms to a set of defined design rules, using, for example, a rules-based process that reports any configuration or network element that does not conform to a given set of user-defined rules.

The operations that need to be performed to accomplish each defined task is stored in a task database 170, and the particular parameters/settings for each of the applications 110-130 to effect the task are stored in setting files 160.

The automation engine 150 is also configured to effect “administrative” tasks that facilitate the proper flow of information among the applications. To facilitate the comparison of data collected at different times, for example, the automation engine 150 can be configured to assure the preservation of prior data before the invocation of an application 110, 120 that may overwrite the prior data, or the prior analysis of the data. For example, the automation engine 150 may guarantee uniqueness of data or analysis files by incorporating a date and time substring with the aforementioned file names. Alternatively, the automation engine 150 may change the name of a prior created file to “old” at the start of the collection of new information or the analysis of new information, and compare any newly created file from the data collection tool 110 or the data analysis tool 120 with this “old” file.

The automation engine 150 is also configured to effect “conditional” tasks, or conditional task sequences. For example, the automation engine 150 may be configured to invoke the data collection tool 110 that collects network configuration information, followed by the invocation of a network validation tool 120, followed by the generation of a report by the report server 130, if the network validation tool 120 identifies a configuration error.

Similarly, the automation engine 150 may be configured to invoke a data collection tool 110, and a network difference tool 120, and then selectively invoke another data collection 110 or analysis 120 tool, based on whether a difference in the network configuration is determined, to assess and report any performance degradations or anomalies that appear to be correlated to the detected network change. These and other conditional invocations of applications/tools by the automation engine 150 will be evident to one of ordinary skill in the art in view of this disclosure.

The automation engine 150 includes a user interface (not illustrated) that facilitates the definition and storage of individual tasks and sequences of tasks in the task database 170. These stored tasks can be invoked from the scheduler 170 on-demand, or the automation engine 150 can be configured to execute select tasks or sequences of tasks at particular times or at particular time intervals. In a preferred embodiment of the automation engine 150, the execution of a task or sequence of task is based on the occurrence of an event, and this event can be any combination of a user-induced event, a timed event, an anticipated event, an anomalous event, an alarm event, and so on.

To facilitate the use of the automation engine 150, the accessible applications/tools within the network management arsenal are preferably designed/modified to facilitate the selective invocation of each tool as the situation demands. Of particular note, the parameters/settings associated with each application/tool for inclusion within a given task are preferably stored for access by the automation tool 150 to facilitate the successful execution of each application within a given task, without human intervention.

Conventional task scheduling processing employ “scripts”, which are copies of the interactions required at an application's graphic user interface (GUI) to effect the task. The interactions required at the application's GUI are typically recorded in a script file as the user interacts with the application to perform a given task, then played-back as an input to the GUI to repeat this same set of interactions for subsequent repetitions of the task. For simple applications, such a mimicking of user interactions is sufficient, but complicated applications, such as those typically used for network data collection 110 and network analysis 120, a user's interaction with the GUI is rarely error-free, or straightforward, particularly if the application interacts with the GUI throughout the performance of a task. For example, a data analyzer 120 may ask for a destination file for storing its results only after it has analyzed sufficient data to produce these results, or a data collector 110 may ask for the identification of a target node from which to collect data only after searching the network to create an up-to-date network topology. As such, the capture of a set of inputs to a GUI that will be reliable for repeated tasks is often a difficult and time consuming process.

Alternatively, many simple applications allow for “command-line parameters”, wherein the parameters required to run the application for a given task are provided to the application as part of the command that initiates execution of the application.

Although the automation engine 150 may be configured to provide input-scripts or command-line parameters to each scheduled application 110, 120, 130, in a preferred embodiment of this invention, the automation engine 150 provides a select setting file 160 to each scheduled application, as illustrated in FIG. 2.

FIG. 2 illustrates an example control of an application/tool 210 by an automation engine 150 in accordance with this invention. In a preferred embodiment of this invention, each application/tool 210 is configured to perform a given task by either receiving input via a GUI, or receiving parameters/settings from a settings file 160, depending upon the state of an input switch 215.

With the switch 215 in the indicated position in FIG. 2, the GUI 220 is used to interact with a user as the application 210 provides input to the processes 212 from the user to effect the desired task(s), and provides output to the user from the processes 212 as appropriate. As is common in the art, each application 210 and process 212 typically contains internal data structures within which the parameters required to perform a given task or set of tasks are stored. The GUI 220 provides a means for querying the user for the input that is used to create these parameters. In some cases, the user input is the stored parameter, in many cases, the GUI 220 and/or the process 212 pre-process the user input to create the appropriate stored parameters.

When the switch 215 is in the opposite position than indicated in FIG. 2, each process 212 receives the parameters required to effect the desired task from the settings file 160, and provides output to a log file 240. Preferably, these parameters correspond to the parameters that are stored in the internal data structures, thereby avoiding, or reducing, the need to pre-process the input to create the parameters that are stored in these internal data structures.

FIG. 3 illustrates an example method of creating settings data 160 for configuring an application/tool 210 in accordance with this invention. In a preferred embodiment, a user runs an application 210, or prepares to run the application 210, by interacting with the GUI 220. Depending upon the structure of the application 210, the user is provided the option of incrementally storing determined parameters from the application 210, or storing all of the parameters from the application 210, to the settings file 160. Preferably, each major option-selecting portion of the application 210 includes the option of storing the parameters associated with each portion to the settings file 160. Also preferably, the application 210 can be configured to read the parameters from the settings file 160 up to a select point in the application 210, at which point the user is provided the option of interacting via the GUI to create new parameters, and thereby create variants of existing settings files 160.

Also in a preferred embodiment, the state of the switch 215 of FIG. 2 is controllable by the user of the application, via, for example, an initial input via the GUI 220, or via a command-line parameter when the application is initiated. In this manner, a user can verify the proper operation of the application 210 using these settings 160, before scheduling the automation engine 150 to run this applicant 210.

Of particular note, the above described configuration of a network monitoring system in accordance with this invention allows for a partitioning of the responsibilities associated with managing a complex network. Technical personnel who are well versed in the particular aspects and characteristics of each application 110, 120, 130, for example, are provided an architecture within which to define, test, and debug defined tasks 170, and settings 160 for each application for each task to accomplish a given function, while network management personnel are provided the architecture to schedule and perform the tasks required to properly maintain the network, without being required to understand the idiosyncrasies of each tool or the interactions among tools.

The foregoing merely illustrates the principles of the invention. It will thus be appreciated that those skilled in the art will be able to devise various arrangements which, although not explicitly described or shown herein, embody the principles of the invention and are thus within its spirit and scope. For example, although FIG. 1 illustrates that the automation engine 150 effects some control over each of the data collectors 110, data analyzers 120, and report server 130 processes, some or all of a process's tasks may be accomplished independent of the automation engine 150. In a typical environment, the automation engine 150 may only control the data collectors 110 and data analyzers 120, and the report server 130 is operated in a stand-alone mode, using the data provided by the data analyzer 120. These and other system configuration and optimization features will be evident to one of ordinary skill in the art in view of this disclosure, and are included within the scope of the following claims.

In interpreting these claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function;
e) each of the disclosed elements may be comprised of hardware portions (e.g., including discrete and integrated electronic circuitry), software portions (e.g., computer programming), and any combination thereof;
f) hardware portions may be comprised of one or both of analog and digital portions;
g) any of the disclosed devices or portions thereof may be combined together or separated into further portions unless specifically stated otherwise; and
h) no specific sequence of acts is intended to be required unless specifically indicated.

1. A network monitoring system comprising:
at least two of the following three applications:
one or more data collectors,
one or more data analyzers,
one or more data reporters;
one or more task definitions, and
an automation engine that is configured to control the at least two components to effect a target task based on the one or more task definitions.

2. The network monitoring system of claim 1, wherein
the automation engine is configured to effect the target task based upon an occurrence of an event,
the event including at least one of:
a user-induced event,
a timed event,
an anticipated event,
an anomalous event, and
an alarm event.

3. The network monitoring system of claim 1, wherein
each of the at least two applications is configured to selectively receive input from either a user-interface or a stored set of inputs that provides parameters that define operational characteristics of the application to perform the target task.

4. The network monitoring system of claim 3, wherein
the stored set of inputs includes settings that provide the parameters, independent of the user-interface.

5. The network monitoring system of claim 4, wherein
the settings are stored values of the parameters that were determined after receiving the input from the user-interface.

6. The network monitoring system of claim 4, wherein
the settings correspond to the parameters of the application that are stored in an internal data-structure of the application to facilitate control of processes within the application to perform the target task.

7. The network monitoring system of claim 3, wherein
the stored set of inputs are stored in a collection of setting files, and
the automation engine is configured to selectively provide a setting file from the collection of setting files to each of the at least two applications based on the one or more task descriptions.

8. The network monitoring system of claim 7, wherein
each of the one or more task descriptions includes an identification of a select setting file for each application that is included in the task description.

9. The network monitoring system of claim 1, wherein
the data collectors include applications that:
facilitate the collection of performance data from a network and
include performance monitoring capabilities that can be queried from the network management system.

10. The network monitoring system of claim 1, wherein
the data collectors include applications that:
facilitate the collection of configuration data from a network, and
include configuration monitoring capabilities that can be queried from the network management system.

11. The network monitoring system of claim 1, wherein
the data analyzers include applications that provide at least one of:
flow analysis,
failure analysis,
security analysis,
network differences, and
network validation.

12. The network monitoring system of claim 1, wherein
the automation engine is configured to:
import network configuration data, via the one or more data collectors, and
determine differences in the network configuration data from a reference set of configuration data, via the one or more data analyzers.

13. The network monitoring system of claim 12, wherein
the automation engine is further configured to
issue one or more reports based on the differences, via the one or more data reporters.

14. The network monitoring system of claim 13, wherein
the automation engine is further configured to:
import network performance data, via the one or more data analyzers, and
include some or all of the network performance data in the one or more reports.

15. The network monitoring system of claim 1, wherein
the automation engine is configured to:
import network configuration data, via the one or more data collectors, and
determine conformance of the network to one or more design rules, based on the network configuration data, via the one or more data analyzers.

16. The network monitoring system of claim 15, wherein
the automation engine is further configured to
issue one or more configuration-error reports based on the conformance of the network to the one or more design rules, via the one or more data reporters.

17. The network monitoring system of claim 16, wherein
the automation engine is further configured to:
import network performance data, via the one or more data analyzers, and
include some or all of the network performance data in the one or more reports.

18. The network monitoring system of claim 15, wherein
the one or more design rules are configured to indicate latent problems in configurations of devices in the network that will adversely affect the network, based on the imported network configuration data.

19. A method of automating network analysis, comprising:
configuring an automation engine to:
import network configuration data from one or more devices on a network,
analyze the network configuration data to identify differences from a reference set of configuration data, and
provide a report of the differences and
enabling the automation engine.

20. A method of detecting network configuration errors, comprising:
configuring an automation engine to:
import network configuration data from one or more devices on a network,
analyze the network configuration data to identify configuration errors, based on one or more configuration rules, and
provide a report of the configuration errors, and
enabling the automation engine.

21. The method of claim 20, wherein
the configuration rules are configured to indicate latent problems in a configuration of a device that will have a negative impact on network performance.

22. A method of monitoring a network, comprising:
creating one or more task definitions that facilitate control of:
one or more data collectors, and
one or more data analyzers; and
configuring an automation engine to process the one or more task definitions to effect the control the data collectors and data analyzers, and
enabling the automation engine.

23. The method of claim 22, wherein
enabling the automation engine is based upon an occurrence of an event,
the event including at least one of:
a user-induced event,
a timed event,
an anticipated event,
an anomalous event, and
an alarm event.

24. The method of claim 22, wherein
configuring the automation engine includes identifying one or more setting files from a collection of setting files to effect the control of at least one of the data collectors and data analyzers.

25. The method of claim 24, wherein
creating the one or more task descriptions includes identifying the one or more setting files to perform each task.

26. The method of claim 22, wherein
at least one of the task definitions is configured to effect:
importing network configuration data, via the one or more data collectors,
determining differences in the network configuration data from a reference set of configuration data, via the one or more data analyzers, and
reporting the differences.

27. The method of claim 26, wherein
the at least one task definition is further configured to effect:
importing network performance data, via the one or more data collectors, and
reporting the performance data.

28. The method of claim 22, wherein
at least one of the task definitions is configured to effect:
importing network configuration data, via the one or more data collectors,
determining conformance of the network to one or more design rules, based on the network configuration data, via the one or more data analyzers, and
reporting conformance-errors, based on the conformance of the network to the one or more design rules.

29. The method of claim 28, wherein
the at least one task definition is further configured to effect:
importing network performance data, via the one or more data collectors, and
reporting the performance data.

30. The method of claim 28, wherein
the one or more design rules are configured to indicate latent problems in configurations of devices in the network that will adversely affect the network, based on the imported network configuration data.
